(19) United States
(12) Patent Application Publication
(10) Pub. No.: US 2009/0295248 A1
(43) Pub. Date: Dec. 3, 2009

(54) ELECTRIC MOTOR

(76) Inventors: Yongbin LI, Shenzhen (CN); Weifeng Yuan, Hong Kong (CN); Ning Sun, Shenzhen (CN); Xinping Wang, Shenzhen (CN)

Correspondence Address: Muncy, Geissler, Olds & Lowe, PLLC, P.O. BOX 1364, FAIRFAX, VA, 22038-1364, US

(21) Appl. No.: 12/474,631

(22) Filed: May 29, 2009

(30) Foreign Application Priority Data
May 30, 2008 (CN) 200810067544.4

(51) Int. Cl. H02K 1/30

(52) U.S. Cl. 310/156.53; 310/156.54

(57) ABSTRACT

An electric motor includes a stator with a stator core and a rotor. The rotor includes n magnets polarized along the radial direction of the rotor. The magnets have the same polarization and each forms two magnetic circuits passing through corresponding portions of the stator core, whereby the rotor forms 2n magnetic poles.

### CROSS REFERENCE TO RELATED APPLICATIONS

This non-provisional patent application claims priority under 35 U.S.C. §119(a) from Patent Application No. 200810067544.4 filed in The People's Republic of China on May 30, 2008.

### FIELD OF THE INVENTION

The present invention relates to electric motors and in particular to permanent magnet brushless direct current (PM BLDC) motors.

### BACKGROUND OF THE INVENTION

Usually, a PM BLDC motor includes a stator and a rotor rotatable with respect to the stator. The rotor has at least one permanent magnet installed thereon. The stator comprises a stator core and windings wound on the stator core. The windings generate a magnetic field which coacts with the permanent magnets to drive the rotor to rotate relative to the stator. The rotor may be a so called surface mounted permanent magnet rotor in which the magnet(s) are mounted on the surface of the rotor core or a so called insert permanent magnet rotor, in which the magnets are located in holes formed in the rotor core.

FIG. 6 shows a conventional insert permanent magnet rotor 100 which has four permanent magnets 104 inserted in slots or holes of the rotor core 102. The magnets are polarized along the radial direction of the rotor. Circumferentially adjacent magnets have opposite magnetic poles. The four magnets 104 cooperatively form four magnetic poles. That is, the number of magnets is the same as the number of the poles and each magnetic circuit is formed by two magnets in series. Magnetic flux of the magnets 104 is indicated by lines in FIG. 7.

However, this traditional rotor configuration is not suitable for low power motors such as an automotive fuel pump and sintered magnets, because of the small rotor size. For example, for a fuel pump with power of 10 to 30 watt, permanent magnets with 1 mm depth can satisfy magnetic requirement of the rotor of the pump. However, thin magnets are easy to be damaged during assembly. To thicken the magnets in order to avoid being damaged in assembly will results in low utilization ratio and waste of magnet material. Furthermore, two adjacent magnets formed with opposite magnetic poles will cause the assembly process to be complicated.

As such, there is a desired for an improved PM BLDC motor which can solve the above-mentioned problems.

### SUMMARY OF THE INVENTION

Accordingly, in one aspect thereof, the present invention provides an electric motor comprising a stator with a stator core and a rotor, wherein the rotor comprises n magnets each of which forms two magnetic circuits passing through corresponding portions of the stator core, whereby the rotor forms 2n magnetic poles.

Preferably, the magnets are polarized along the radial direction of the rotor and have the same polarization.

Preferably, the electric motor is a permanent magnet brushless direct circuit motor, the stator comprising a plurality of stator poles.

Preferably, the rotor is rotatably installed in the stator and the rotor comprises a rotor core.

Preferably, the magnets are fully located within the rotor core in the radial direct of the rotor.

Preferably, the magnets are fixedly mounted to surfaces of the rotor core.

Preferably, the peripheral edge of the cross section of the rotor core is located at a circle the center of which is located on the axis of the rotor.

Preferably, portions of the peripheral edge of the rotor core corresponding to the magnets in the radial direction of the rotor are closer to the axis of the rotor compared to portions of the peripheral edge of the rotor core circumferentially offset from the magnets, whereby gaps formed between portions of the peripheral edge of the rotor core corresponding to the magnets and corresponding stator poles being greater than gaps formed between portions of the peripheral edge of the rotor core circumferentially offset from the magnets and corresponding stator poles.

Preferably, the rotor core defines at least a pair of axially extending holes in order to keep the center of gravity of the rotor substantially at the axis of the rotor.

Preferably, the rotor comprises a pair of magnets disposed at diametrically opposite sides of the rotor core, the holes being disposed at locations circumferentially equally spaced from the magnets.

Preferably, the rotor is rotatably installed outside of the stator, the rotor further comprising a housing and n rotor cores, the rotor cores and magnets being alternatively disposed the circumferential direction on a radially inner surface of the housing.

Preferably, gaps formed between the magnets and corresponding stator poles are greater than gaps formed between the rotor cores and corresponding stator poles.

According to a second aspect thereof, the present invention also provides a rotor for an electric motor comprising a rotor core and n magnets mounted to the rotor core, the magnets being polarized along the radial direction of the rotor and having the same polarization.

Preferably, peripheral edges of portions of the rotor core corresponding to the magnets in the radial direction of the rotor are closer to the axis of the rotor than peripheral edges of portions of the rotor core circumferentially spaced from the magnets.

Preferably, an air gap between a stator pole and a portion of the rotor adjacent a magnet is greater than an air gap between a stator pole and a portion of the rotor located circumferentially spaced between adjacent magnets.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1A shows a PM BLDC rotor in accordance with an embodiment of the present invention;

FIG. 1B shows a PM BLDC rotor in accordance with an alternative embodiment of the present invention;

FIG. 2 shows the magnet field distribution of a motor incorporating the rotor of FIG. 1B;

FIG. 3 is an graph showing Back EMF v Position of Rotor for the motor of FIG. 2, indicating magnetic field strength between the stator and rotor;

FIG. 4 shows a PM BLDC rotor in accordance with a further embodiment of the present invention;

FIG. 5 shows a motor applying an outer rotor in accordance with an additional embodiment of the present invention;

FIG. 6 shows a conventional insert-type permanent magnet rotor; and

FIG. 7 shows the magnet field distribution of a motor having the prior art rotor of FIG. 6.

### DESCRIPTION OF THE PREFERRED EMBODIMENT

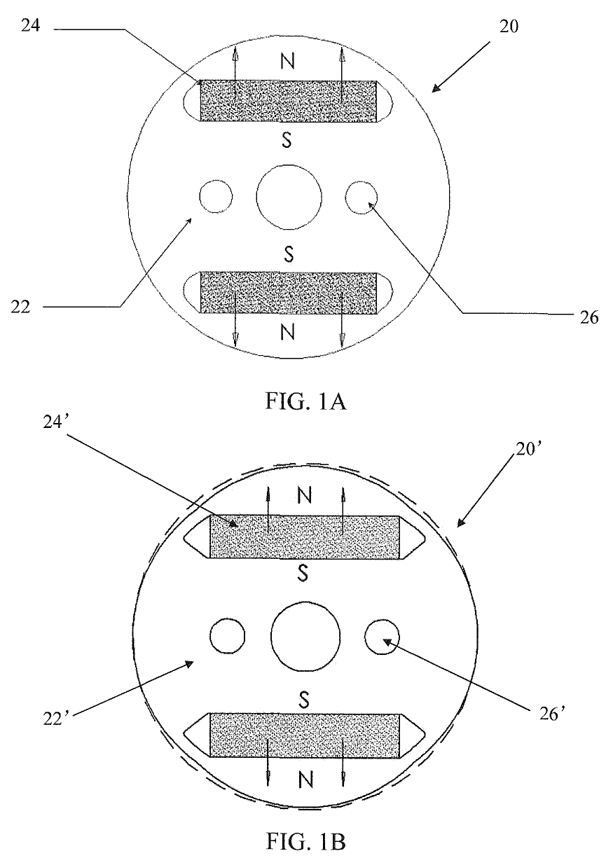

FIG. 1A shows a PM BLDC rotor 20 in accordance with an embodiment of the present invention. Rotor 20 comprises a rotor core 22 comprising a plurality of laminations stacked along the axis of the rotor 20, and a pair of permanent magnets 24 inserted in diametrically opposite sides of the rotor core 22. The magnets 24 are polarized in the radial direction of the rotor 20 and have the same polarization. A pair of holes 26 extending in the axial direction of the rotor 20 are located at diametrically opposition locations circumferentially spaced between the magnets in order to keep the center of gravity of the rotor 20 substantially at the center of the rotor core 22, i.e., on the axis of the rotor 20. The peripheral edge of the rotor core is located at a circle, the center of which is located on the axis of the rotor 20. Preferably, the magnets 24 are made of rare earth materials.

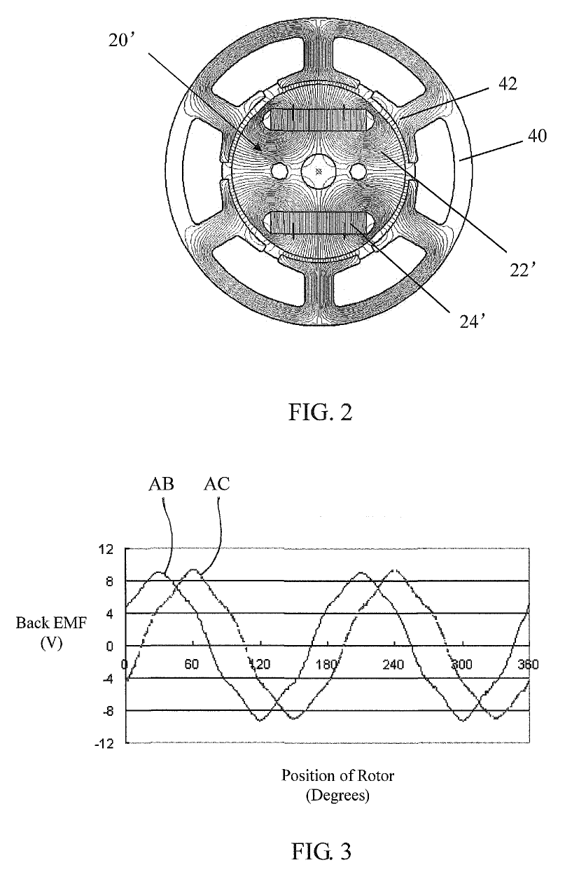

FIG. 1B shows a PM BLDC rotor 20′ in accordance with an alternative embodiment of the present invention. The rotor 20′ has a structure similar to that of the rotor 20 except that diametrically opposite parts of the peripheral edge of the rotor core 22′ of the rotor 20′ facing the magnets 24′ in the radial direction of the rotor 20′ are partly cut away. That is, a portion of the peripheral edge of the rotor core 22′ corresponding to the magnets 24 in the radial direction of the rotor are closer to the axis of the rotor than the remainder of the peripheral edge of the rotor core or at least portions of the peripheral edge circumferentially offset from the magnets. As such, radial gaps formed between parts of the peripheral edge of the rotor core 22′ corresponding to the magnets and corresponding stator poles 42 are greater than gaps formed between parts of the peripheral edge of the rotor core 22′ offset from the magnets and corresponding stator poles 42, as shown in FIG. 2. As shown in FIG. 1B, the preferred portions are those portions adjacent the circumferential ends of the magnets. Ideally, the shape of the peripheral edge of the rotor core is smoothly shaped with the radial dimension being a minimum in the area of the circumferential ends of the magnets and a maximum in the portion between the magnets. The portion radially opposite the center of each magnet may have a radial dimension equal to the maximum but is preferably less than the maximum and more than the minimum.

FIG. 2 is a schematic view of a motor having a stator core and the rotor of FIG. 1B, in which magnetic flux of the magnets 24′ is indicated by shaded lines. The stator windings are omitted for clarity and ease of drawing. The magnetic flux emitted from the north pole of each of the magnets 24′ passes through a corresponding portion of the stator core 40 and then returns to the south pole of the same magnet 24′. Each magnet 24′ forms two magnetic circuits and thus the pair of magnets 24′ forms four magnetic circuits. That is, each magnet 24′ forms two magnet poles and two consequent poles (virtual or iron poles). Each magnetic circuit has a magnet pole and its consequent pole generated by one magnet 24′.

In the above-mentioned embodiments, by using just half the number of magnet pieces with the same polarizations it is capable of achieving the same number of poles as if using equal number of magnet and rotor poles, for example, with two pieces magnets, four rotor poles can be achieved consequently, which simplifies the rotor assembly process. Furthermore, utilization ratio of the rare earth magnets is increased and the magnet can be made with a comparatively greater thickness, which will greatly reduce the chances of the magnet being broken during assembly of the magnet assembly. In addition, asymmetrical air gap between a stator pole and a corresponding magnet pole and its consequent pole (virtual or iron pole) adopted in the alternative embodiment can achieve symmetrical magnetic field distribution along the full air gap in the circumferential direction of the rotor, as shown in FIG. 3. The symmetrical magnetic field distribution is not only good for the noise and vibration performance improvement, but also for increasing the fuel flow in the fuel pump application.

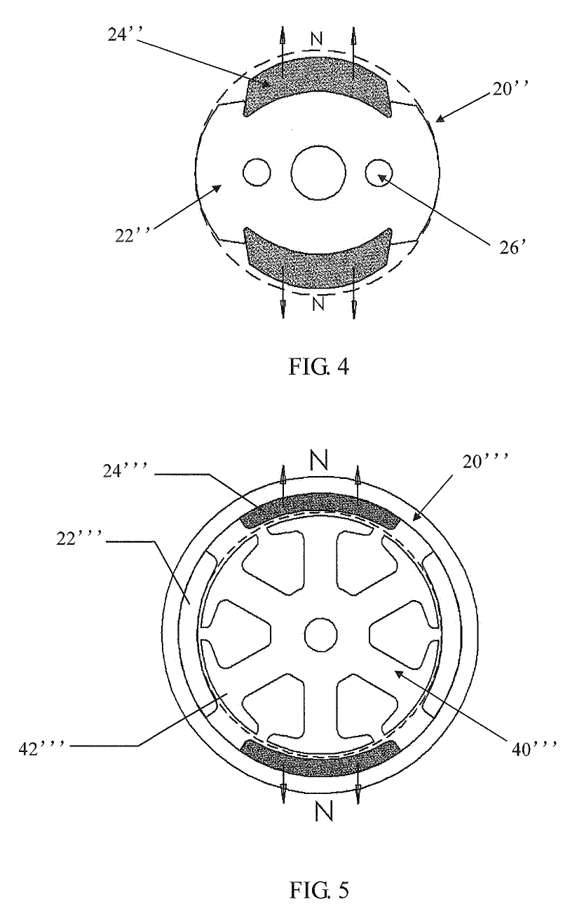

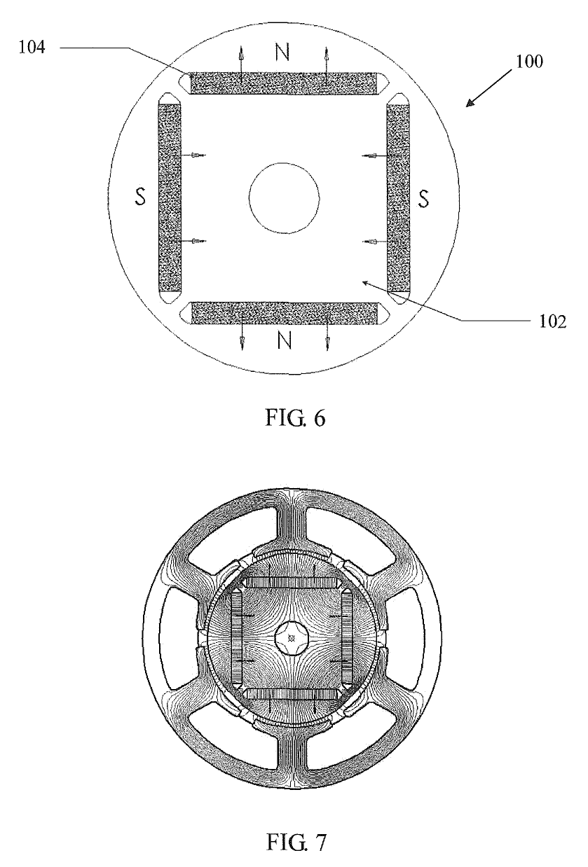

FIG. 4 shows a PM BLDC rotor 20″ in accordance with a further embodiment of the present invention, which is similar to the rotor 20′ except the magnets 24″ are curved and mounted to the surface of cut portions at diametrically opposite sides of the rotor core 22″.

In the above embodiments, the rotor is rotatably located within the stator. Alternatively, as shown in FIG. 5, the motor may comprise an outer rotor 20′″ and an inner stator 40′″. The rotor 20′″ comprises two curved magnets 24′″ and two curved cores 22′″ mounted on the inner surface of the housing of the rotor 20′″. The radial air gap between corresponding stator poles and the magnets 24′″ is greater than the radial air gap between corresponding stator poles and the cores 22′″, in order to achieve symmetrical magnetic field distribution along the full air gap in the circumferential direction of the rotor.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

What is claimed is:

1. An electric motor comprising a stator with a stator core and a rotor, wherein the rotor comprises n magnets each of which forms two magnetic circuits passing through corresponding portions of the stator core, whereby the rotor forms 2n magnetic poles.

2. The electric motor of claim 1, wherein the magnets are polarized along the radial direction of the rotor and have the same polarization.

3. The electric motor of claim 1, wherein the electric motor is a permanent magnet brushless direct circuit motor, the stator comprising a plurality of stator poles.

4. The electric motor of claim 3, wherein the rotor is rotatably installed in the stator and the rotor comprises a rotor core.

5. The electric motor of claim 4, wherein the magnets are fully located within the rotor core in the radial direct of the rotor.

6. The electric motor of claim 4, wherein the magnets are fixedly mounted to surfaces of the rotor core.

7. The electric motor of claim 4, wherein the peripheral edge of the cross section of the rotor core is located at a circle the center of which is located on the axis of the rotor.

8. The electric motor of claim 4, wherein portions of the peripheral edge of the rotor core corresponding to the magnets in the radial direction of the rotor are closer to the axis of the rotor compared to portions of the peripheral edge of the rotor core circumferentially offset from the magnets, whereby gaps formed between portions of the peripheral edge of the rotor core corresponding to the magnets and corresponding stator poles being greater than gaps formed between portions of the peripheral edge of the rotor core circumferentially offset from the magnets and corresponding stator poles.

9. The electric motor of claim 4, wherein the rotor core defines at least a pair of axially extending holes in order to keep the center of gravity of the rotor substantially at the axis of the rotor.

10. The electric motor of claim 9, wherein the rotor comprises a pair of magnets disposed at diametrically opposite sides of the rotor core, the holes being disposed at locations circumferentially equally spaced from the magnets.

11. The electric motor of claim 3, wherein the rotor is rotatably installed outside of the stator, the rotor further comprising a housing and n rotor cores, the rotor cores and magnets being alternatively disposed the circumferential direction on a radially inner surface of the housing.

12. The electric motor of claim 11, wherein gaps formed between the magnets and corresponding stator poles are greater than gaps formed between the rotor cores and corresponding stator poles.

13. A rotor for an electric motor comprising a rotor core and n magnets mounted to the rotor core, the magnets being polarized along the radial direction of the rotor and having the same polarization.

14. The rotor of claim 13, wherein peripheral edges of portions of the rotor core corresponding to the magnets in the radial direction of the rotor are closer to the axis of the rotor than peripheral edges of portions of the rotor core circumferentially spaced from the magnets.

15. A rotor according to claim 13, wherein an air gap between a stator pole and a portion of the rotor adjacent a magnet is greater than an air gap between a stator pole and a portion of the rotor located circumferentially spaced between adjacent magnets.
